(19) United States
(12) Patent Application Publication
(10) Pub. No.: US 2026/0360844 A1
(43) Pub. Date: Nov. 12, 2026

(54) SYSTEM FOR CONTROLLING TEMPERATURE OF BATTERY AND METHOD FOR CONTROLLING TEMPERATURE OF BATTERY

(71) Applicant: Standard Energy Inc., Daejeon (KR)

(72) Inventors: Dongyoung Lee, Daejeon (KR); Bugi Kim, Daejeon (KR)

(21) Appl. No.: 19/141,030

(22) PCT Filed: Dec. 19, 2023
(86) PCT No.: PCT/KR2023/020957

§ 371 Date: Jun. 18, 2025

(30) Foreign Application Priority Data
Dec. 20, 2022 (KR) 10-2022-0179678

(51) Int. Cl. H01M 10/44; H01M 10/24; H01M 10/613; H01M 10/615; H01M 10/633; H01M 10/6561; H01M 10/663; H02J 7/00

(52) U.S. Cl. CPC H01M 10/443; H01M 10/24; H01M 10/613; H01M 10/615; H01M 10/633; H01M 10/6561; H01M 10/663; H02J 7/865

(57) ABSTRACT

This method for controlling the temperature of a battery comprises: measuring the temperature of the battery and the external temperature of a container including the battery; charging or discharging the battery; and controlling the temperature of the battery, wherein the controlling of the temperature of the battery may comprise: increasing the temperature of the battery by introducing air outside the container if the external temperature is higher than the temperature of the battery while the battery is being charged, or lowering the temperature of the battery by introducing air outside the container if the external temperature is lower than the temperature of the battery while the battery is being discharged. A method for controlling the temperature of a battery in an emergency situation may comprise: recognizing an emergency situation when the temperature of the battery increases to above a first threshold value; charging the battery in response to the emergency situation; lowering the temperature of the battery on the basis of a C-rate (current rate) of the battery; recognizing an emergency situation when the temperature of the battery decreases to below a second threshold value; discharging the battery in response to the emergency situation; and increasing the temperature of the battery on the basis of the C-rate (current rate) of the battery.

### TECHNICAL FIELD

Embodiments relate to a system for controlling a temperature of a battery and a method for controlling a temperature of a battery.

### BACKGROUND

Along with the recent development of IT devices and network technology and the consequent increase in society's reliance on energy, the effective utilization of energy has become a critical issue. In particular, there is a continuous demand for technologies that efficiently store and utilize electrical energy, which is the most conveniently used form of energy.

Among these technologies, the use of batteries in various energy utilization devices is increasingly active. Therefore, it is necessary to improve the efficiency of battery charging and discharging as much as possible in an economical manner.

Generally, technologies that store energy in a limited space, such as batteries, are directly related to a system operating time. In the case of batteries, there is a constant demand for improvements in energy storage systems, battery capacity, and efficiency during charging and discharging. Accordingly, various efforts have been made, such as system designs and conditions to maximize voltage efficiency. However, these efforts face limitations due to various constraints.

### DISCLOSURE

### Technical Problem

Embodiments are intended to effectively improve voltage efficiency during battery charging and discharging.

Therefore, an object of embodiments is to provide a battery charging and discharging method that enables charging and discharging with excellent voltage efficiency by adjusting a charging and discharging environment.

Another object of embodiments is to provide a charging and discharging management system that economically manages battery charging and discharging to achieve excellent voltage efficiency.

A further object of embodiments is to provide a control method and system for stabilizing the temperature of a battery, when an emergency situation occurs during battery charging and discharging.

### Technical Solution

To solve the above-described problems, a method for controlling a temperature of a battery may include measuring the temperature of the battery and an external temperature of a container including the battery, charging or discharging the battery, and controlling the temperature of the battery. Controlling the temperature of the battery may include, when the external temperature is higher than the temperature of the battery while the battery is being charged, increasing the temperature of the battery by introducing external air of the container, or when the external temperature is lower than the temperature of the battery while the battery is being discharged, decreasing the temperature of the battery by introducing external air of the container.

A method for controlling a temperature of a battery in an emergency situation may include, when the temperature of the battery increases higher than a first threshold, recognizing the emergency situation, charging the battery in response to the emergency situation, and decreasing the temperature of the battery based on a current rate (C-rate) of the battery, when the temperature of the battery decreases lower than a second threshold, recognizing the emergency situation, discharging the battery in response to the emergency situation, and increasing the temperature of the battery based on the C-rate of the battery.

### Advantageous Effects

Embodiments provide an effect of enabling charging and discharging with excellent voltage efficiency by controlling charging and discharging temperatures of a battery.

Therefore, when the battery charging and discharging method of embodiments is applied, energy efficiency is excellent, which may greatly contribute to energy saving.

Further, the battery charging and discharging method of embodiments may apply a very economical control scheme by applying a cooling or heating algorithm for adjusting charging and discharging temperatures, such that when heating is required, heating is turned on only during charging and turned off during discharging, and when cooling is required, cooling is turned on only during discharging. Therefore, the electricity consumption for heating may be significantly reduced, and efficiency may also be increased, resulting in a very economical effect. In addition, the use of an air conditioner capable of introducing external air to adjust a charging and discharging temperature environment may enable utilization of an external temperature, which also leads to the effect of energy saving.

Further, the method and apparatus of embodiments provide an effect of efficiently and quickly stabilizing the temperature of a battery in an emergency situation, for example, a fire risk situation.

### BRIEF DESCRIPTION OF THE DRAWINGS

The drawings are included to provide a further understanding of embodiments and, together with a relevant description, illustrate the embodiments. For a better understanding of various embodiments described below, reference should be made to the following description of the embodiments in connection with the following drawings, throughout which like reference numerals denote corresponding parts.

FIG. 1 illustrates voltage efficiency measurement results of temperature control during charging or discharging in a battery charging and discharging method according to embodiments.

FIGS. 2 and 3 illustrate the structure of a container including a battery according to embodiments.

FIG. 4 illustrates control of external air of a container including a battery according to embodiments.

FIG. 5 illustrates temperature control based on charging and discharging of a battery according to embodiments.

FIG. 6 illustrates a method for controlling a temperature of a battery according to embodiments.

FIG. 7 illustrates a method for controlling a temperature of a battery in an emergency situation according to embodiments.

FIG. 8 illustrates a system for controlling a temperature of a battery according to embodiments.

### BEST MODE

A detailed description will be given below of a preferred one of embodiments in detail, examples of which are illustrated in the accompanying drawings. The following detailed description with reference to the accompanying drawings is intended to explain the preferred embodiment rather than to illustrate the only embodiment that may be be implemented according to the embodiments. The following detailed description includes details to provide a thorough understanding of the embodiments. However, it will be apparent to those skilled in the art that the embodiments may be practiced without these details.

Most of the terms used in the embodiments are selected from general terms widely used in the art, but some terms are arbitrarily selected by the applicant, and their meanings are described in detail in the following description as needed. Therefore, the embodiments should be understood based on the intended meaning of the terms, not on the simple names or meanings of the terms.

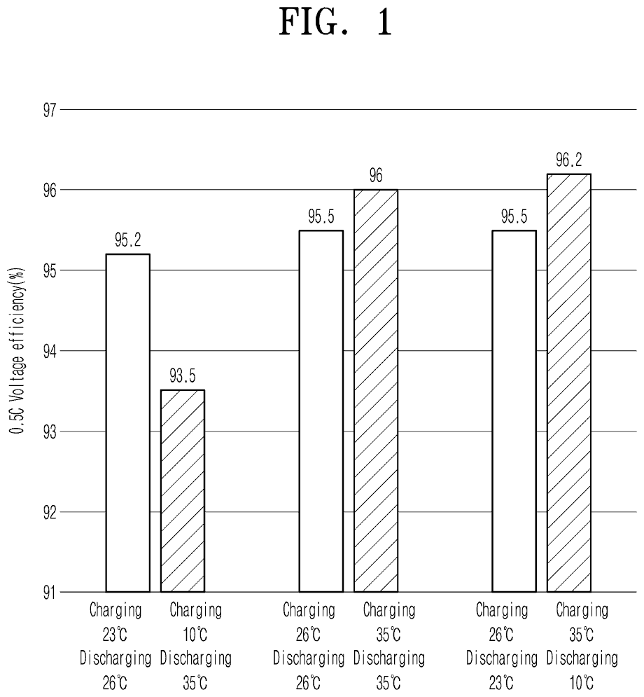

FIG. 1 illustrates voltage efficiency measurement results of temperature control during charging or discharging in a battery charging and discharging method according to embodiments.

Embodiments relate to a battery charging and discharging method and a charging and discharging system, which enable excellent voltage efficiency through temperature control during battery charging and discharging. Embodiments provide a technical solution for creating an environment for battery charging and discharging with high energy efficiency in a high power and low temperature environment.

In embodiments, during charging and discharging a battery, a charging temperature is higher than a discharging temperature. More specifically, it is a method for performing charging at a charging temperature equal to or higher than a discharging temperature.

Therefore, embodiments significantly improve voltage efficiency by charging the battery at a temperature equal to or higher than a discharging temperature and discharging the battery at a temperature equal to or lower than a charging temperature.

According to a preferred embodiment, it is necessary to fundamentally adjust a temperature environment in a manner that satisfies the above condition during charging and discharging of the battery. To this end, the temperature environment may typically be adjusted by performing heating or cooling. According to embodiments, heating may be performed and cooling may not be performed during charging of the battery. This is because it is preferable to perform charging at a higher temperature than discharging. Therefore, there is no need to control the temperature to a low temperature through cooling during charging.

In addition, during discharging of the battery, an environmental condition may be maintained in which cooling is performed and heating is not performed. This is because of the charging and discharging environmental condition of embodiments, in which it is preferable to perform discharging at a lower temperature than charging. This is also because there is no reason for heating during discharging due to a discharging condition advantageous at a low temperature.

According to embodiments, in the case where temperature control is required during battery charging and discharging, when there is a difference between a charging and discharging environment and an external temperature, external air may be used for the temperature control. Therefore, embodiments may include, for example, a step of adjusting the charging and discharging temperature environment by introducing external air into the interior during charging and discharging.

According to embodiments, when the charging environment is lower than the external temperature during charging, a step of increasing the temperature by introducing external air may be included. This case may usually be applied in summer when the external temperature is very high.

According to embodiments, when the discharging environment is higher than the external temperature during discharging, a step of decreasing the temperature by introducing external air may be included. For example, in winter when the external temperature is low, the voltage efficiency may be increased during discharging by lowering the discharging temperature environment by utilizing such low-temperature external air.

According to embodiments, when external air is cold in winter, an ESS may be normally insulated. During discharging, a flap is opened and the cold external air is blown in by an air conditioning system such as a ventilation fan to create a discharging environment. When it is time to perform charging, the ESS is warmed by closing the flap in the charging environment, so that the internal temperature of the ESS may be maintained, for example, at about 25 to 35 °C.

According to embodiments, when external air is hotter than the inside in summer, the ESS is normally insulated. During charging, the flap is opened and hot external air is blown in by the ventilation fan to create a charging environment. When it is time to perform discharging, the flap is closed in the discharging environment, and the temperature is decreased by absorbing the remaining heat, so that the internal temperature may be maintained at about 28 to 37 °C.

Since embodiments use such a natural environment, the temperature of the charging and discharging environment may be adjusted without additional energy consumption according to the method of the embodiments, which may be used as a very economical method.

In embodiments, charging is preferably performed in a high temperature condition with a charging temperature equal to or higher than a discharging temperature. For example, it is preferable to perform charging at a temperature of 15 °C or higher, more preferably at 20 to 40 °C. Typically, charging may be performed at room temperature.

According to embodiments, charging may be performed in a temperature environment with a charging temperature of 23 °C or higher, more preferably in a temperature environment with a charging temperature of 26 to 35 °C. According to an embodiment, charging may be performed in a temperature environment of 26±2 °C.

According to embodiments, in response to the above, the battery is discharged in a low temperature condition with a discharging temperature equal to or lower than the charging temperature. According to a preferred embodiment of the present disclosure, discharging is preferably performed in a temperature environment with a discharging temperature of 0 °C or higher, for example, among the low temperatures equal to or lower than the charging temperature.

According to the discharging temperature condition of embodiments, when the charging temperature is room temperature, discharging may be performed in a temperature environment of 23±2 °C. According to embodiments, when charging is performed in a relatively high temperature environment of 35±2 °C, discharging may be performed under the condition of a temperature equal to or less than the charging temperature, for example, preferably in a temperature environment of 10 to 35 °C.

In the method of embodiments, since it may be necessary to adjust the charging and discharging temperature condition, a step of arbitrarily controlling the charging or discharging temperatures to arbitrary temperatures during charging and discharging may be included.

According to embodiments, the battery charging and discharging method may be preferably applied particularly to battery charging and discharging of an ESS. However, it may be applied to general batteries or various ESSs such as small-capacity, medium-capacity, and large-capacity ESSs. Typically, it may be applied to electric vehicle charging stations, for example.

According to embodiments, a battery to which the battery charging and discharging method may be preferably applied may partially or entirely include a vanadium ion battery which enables low-temperature charging and discharging.

Embodiments have an effect of enabling charging and discharging with excellent voltage efficiency by controlling the charging and discharging temperatures of the battery. Therefore, when the battery charging and discharging method of these embodiments is applied, energy efficiency is excellent, which may greatly contribute to energy saving. A system for performing battery charging and discharging by applying the battery charging and discharging method of embodiments may include temperature control means for an environment in which battery charging and discharging is performed. In this case, the temperature control means may include control means for adjusting charging to a temperature environment equal to or higher than a discharging temperature and adjusting or maintaining discharging to a temperature environment equal to or lower than a charging temperature.

According to embodiments, at least one of heating means or cooling means may be included for temperature control of a charging and discharging environment. For example, the heating means may be included for temperature control of the charging environment, and the cooling means may be included for temperature control of the discharging environment.

In addition, according to embodiments, a temperature sensor may be included to enable control by monitoring the charging and discharging temperature environment from time to time. The temperature sensor may sense a temperature at any position in the charging environment or the discharging environment and thus may be used to enable temperature control.

According to embodiments, the temperature sensor, along with the temperature control means, may use a state of charge (SOC) control system that is variously applied to maintain the SOC of an ESS in a preferred state, for example. In addition, external charging and discharging air may be introduced into the interior during charging and discharging, and for this purpose, an air conditioning system may be included.

According to embodiments, the air conditioning system may include first air conditioning means for introducing external air during charging, when a charging environment is lower than an external temperature, and second air conditioning means for introducing external air during charging, when a discharging environment is higher than an external temperature. With the air conditioning control means, the external air may be used preferably by controlling the intake of air appropriately according to a temperature situation.

According to embodiment, the battery charging and discharging system may include an interface including a typical display method so as to constantly monitor the charging and discharging environment including a temperature in a charged or discharged state during charging and discharging, and control the temperature when needed.

Meanwhile, the battery charging and discharging system of embodiments may include temperature environment setting means for arbitrarily setting and controlling the temperature in the charged or discharged state during battery charging and discharging, for example. The temperature environment setting means may arbitrarily set the charging or discharging temperature so that the charging and discharging temperature environments are adjusted to the set temperature conditions. In this case, the system may be configured to be controlled in conjunction with one or more auxiliary means such as the above-described heating means, cooling means, and air conditioning system for using external air.

Further, an ESS including the battery charging and discharging system with excellent voltage efficiency according to embodiments is included. The battery charging and discharging method and the charging and discharging system of the present disclosure may greatly improve voltage efficiency through temperature control. Particularly, they may be preferably used for temperature control by applying a cooling or heating algorithm and thus efficiently controlling heating and cooling.

Therefore, for example, in the charging and discharging temperature environment, when heating is required, heating is performed only during charging and turned off during discharging, and when cooling is required, cooling is performed only during discharging, thereby enabling very economical control of cooling and heating. In addition, embodiments may use external air to adjust the charging and discharging temperature environment.

Therefore, embodiments may significantly reduce electricity consumption for heating or cooling and increase not only energy utilization efficiency but also voltage efficiency by using external air, which is a very economical method.

According to embodiments, a charging and discharging system may be provided, which improves voltage efficiency under optimal charging and discharging conditions by controlling charging and discharging environment temperatures. Particularly, in the system of embodiments, the use of a cooler, a heater, and an air conditioner may be minimized, and a temperature may be controlled by insulation and a ventilation fan in a facility condition of the system configuration, thereby further economically improving the voltage efficiency of the battery such as an ESS. However, if necessary, it is possible to charge and discharge the battery with significantly excellent voltage efficiency through efficient temperature control by using a cooling, heating, and air conditioning system at a minimum.

### Embodiment 1

In charging and discharging a battery, changes in discharging efficiency were measured by keeping discharging constant at 26 °C and increasing a charging environment temperature from 23 °C to 26 °C through control of an ambient environment temperature during charging and discharging. Charging and discharging were performed under various conditions by setting charging temperatures to 23 °C and 26 °C, and also setting discharging temperatures to 23 °C and 26 °C, and the resulting voltage efficiency was measured and illustrated in comparison in FIG. 1.

From the experimental results of FIG. 1, it is identified that when charging was kept constant at 23 °C and discharging was performed by decreasing the temperature from 26 °C to 23 °C, the voltage efficiency (VE) % increased by 0.2 and 0.3, respectively, in Layer 1 and Layer 2.

Further, it is identified that when charging was kept constant at 26 °C and discharging was performed by decreasing the temperature from 26 °C to 23 °C, the VE was not changed or decreased by 0.1 in Layer 1 and Layer 2, respectively. Conversely, when discharging was kept constant at 23 °C and the charging environment temperature was increased from 23 °C to 26 °C, the VE increased by 0.1 and 0.1, respectively, in Layer 1 and Layer 2. When discharging was kept constant at 26 °C and the charging environment temperature was increased from 23 °C to 26 °C, the VE increased by 0.3 and 0.5, respectively, in Layer 1 and Layer 2.

From these experimental results, it is identified that the VE is good when charging is performed at a high temperature and discharging is performed at a low temperature. Further, when the charging environment temperature is increased under the present experimental conditions, the VE tends to increase proportionally.

Therefore, it is identified that the VE increases when the charging environment temperature is increased, and further increases when the charging temperature is high. Conversely, it is identified that although changes in the discharging temperature have a minimal effect on the VE, lowering the discharging ambient temperature has an effect of increasing the VE.

### Embodiment 2

VE was measured in comparison by changing the charging temperature and discharging temperature of the battery in the same manner as in Embodiment 1. Charging and discharging were performed under the temperature condition of a combination of 10 °C and 35 °C, and VE was measured for each result. The results are illustrated in the following table.

TABLE 1

| Experimental | Charging | Discharging | Voltage efficiency |
|---|---|---|---|
| condition | temperature(°C) | temperature (°C) | (%) |
| 2-1 | 10 | 10 | — |
| 2-2 | 35 | 10 | 3% increase |
| | | | compared to 2-1 |
| 2-3 | 35 | 35 | — |
| 2-4 | 10 | 35 | 3% increase |
| | | | compared to 2-3 |

Similar to the results of Embodiment 1, the experimental results reveal that excellent results were obtained when charging was performed at a high temperature and discharging was performed at a low temperature. However, conversely, when charging was performed at a low temperature and discharging was performed at a high temperature, undesirable results were shown. The battery charging and discharging method with excellent voltage efficiency according to embodiments is characterized in that, in performing battery charging and discharging, charging is performed in a temperature environment equal to or higher than a discharging temperature, and discharging is performed at a temperature equal to or lower than a charging temperature. Further, an environmental condition is characteristically maintained, in which heating is performed without cooling during charging of the battery, and cooling is performed without heating during discharging.

The battery charging and discharging method with excellent voltage efficiency according to embodiments may include a step of adjusting the charging and discharging temperature environment by introducing external charging and discharging air into the interior during charging and discharging. It may include a step of increasing the temperature by introducing external air, when the charging environment is lower than an external temperature during charging. It may include a step of decreasing the temperature by introducing external air, when the discharging environment is higher than the external temperature during discharging. Charging may be performed in a temperature environment of 15 °C or higher. Charging may be performed in an environment of 20 to 40 °C. Discharging may be performed in a temperature environment of 0 °C or higher. Charging may be performed in a temperature environment of 23 °C or higher. Charging may be performed in a temperature environment of 26 to 35 °C. Charging may be performed in a temperature environment of 26±2 °C. Discharging may be performed in a temperature environment of 23±2 °C. Charging may be performed in a temperature environment of 35±2 °C, and discharging may be performed in a temperature environment of 10 to 35 °C. It may include a step of controlling a temperature in a charged or discharged state to an arbitrary temperature during charging and discharging. It may be applied to battery charging and discharging of an ESS. The battery may include a vanadium ion battery.

The battery charging and discharging system of embodiments, which is a system for performing battery charging and discharging, characteristically includes temperature control means for the charging and discharging environment of the battery, and the temperature control means includes control means for adjusting charging to a temperature environment equal to or higher than a discharging temperature and adjusting or maintaining discharging in a temperature environment equal to or lower than a charging temperature. It may also include at least one of heating means or cooling means, for temperature control of the charging and discharging environment. The heating means may be included for temperature control of the charging environment. The cooling means may be included for temperature control of the discharging environment. It may also include a temperature sensor and an air conditioning system capable of introducing external charging and discharging air into the interior during charging and discharging. The air conditioning system may include a first air conditioning control means for introducing external air when the charging environment is lower than an external temperature during charging. The air conditioning system may include a second air conditioning control means for introducing external air, when the discharging environment is higher than an external temperature. It may include a controllable interface capable of monitoring the charging and discharging environment including a temperature in the charged or discharged state during charging and discharging.

The battery charging and discharging system of embodiments may include temperature environment setting means for setting and controlling the temperature in the charged or discharged state during charging and discharging.

An ESS including the battery charging and discharging system of embodiments, which is a system for performing battery charging and discharging, may include temperature control means for an environment in which battery charging and discharging is performed, and the temperature control means may include control means for adjusting charging to an environment equal to or higher than a discharging temperature and adjusting or maintaining discharging to a temperature environment equal to or lower than a charging temperature. The battery of the ESS including the battery charging and discharging system of embodiments includes a vanadium ion battery.

In relation to FIG. 1, a method for controlling a temperature of a battery includes measuring the temperature of the battery and an external temperature of a container including the battery during control of charging or discharging of the battery, and controlling to increase the temperature of the battery by introducing external air of the container, when the external temperature is higher than the temperature of the battery during charging of the battery, or to decrease the temperature of the battery by introducing external air of the container, when the external temperature is lower than the temperature of the battery during discharging of the battery.

Referring to FIG. 1, measurement results of voltage efficiency according to temperature control during charging or discharging according to the battery charging/discharging method described in Table 1 are illustrated.

For example, Example 1, in which the battery is charged at 23 °C and discharged at 26 °C, has higher voltage efficiency than Example 2, in which the battery is charged at 10 °C and discharged at 35 °C.

Similarly, Example 3, in which the battery is charged at 35 °C and discharged at 35 °C, has higher voltage efficiency than Example 4, in which the battery is charged at 26 °C and discharged at 26 °C.

Similarly, Example 5, in which the battery is charged at 35 °C and discharged at 10 °C, has higher voltage efficiency than Example 6, in which the battery is charged at 26 °C and discharged at 23 °C.

That is, the method for controlling a temperature of a battery according to embodiments has an effect of increasing the voltage efficiency of the battery during charging and discharging by heating the battery without cooling it during battery charging, and cooling the battery without heating it during battery discharging. The method for controlling a temperature of a battery may control the temperature of the battery through heating, cooling, internal/external air conditioning, and the like.

That is, it is revealed from FIG. 1 that the method for controlling a temperature of a battery according to embodiments has an effect of increasing voltage efficiency by setting a charging temperature higher than a discharging temperature in both cases where the difference between the charging temperature and the discharging temperature is small and large. FIG. 1 illustrates an example of the effect of charging/discharging voltage efficiency for temperatures in the range of 23 to 26 °C close to room temperature and in the range of 10 to 35 °C where seasonal changes may be seen. The method for controlling a temperature of a battery according to embodiments may adjust a temperature environment such that the charging temperature is relatively high and the discharging temperature is low.

The temperature of a place where the battery system is located may vary depending on the season. For example, in South Korea, the battery system may be operated in a four-season environment with various temperature changes such as spring, summer, autumn, and winter.

In the case of a general battery, for example, a lithium-ion battery (LIB), when the charging temperature is high, the voltage efficiency may increase. However, when the temperature becomes too high, it has technical limitations such as fire and other emergency situations.

On the other hand, in the case of a vanadium ion battery (VIB), even if the charging temperature is controlled to be high to increase the voltage efficiency, the risk of fire is rare, thereby stably increasing the voltage efficiency.

In summer with high temperatures, the method for controlling a temperature of a battery according to embodiments may increase the voltage efficiency by increasing the temperature of the battery through heating or introducing high-temperature external air during charging. When high-temperature external air is introduced, power consumption caused by heating may be reduced. Similarly, the voltage efficiency may be increased by decreasing the battery temperature through cooling during discharging.

In summer, the method for controlling a temperature of a battery according to embodiments may increase the temperature by introducing external air during charging and increase the voltage efficiency by performing cooling during discharging, or may not perform cooling to reduce power consumption when the voltage efficiency increase effect is small.

In winter with low temperatures, the method for controlling a temperature of a battery according to embodiments may increase the voltage efficiency by increasing the temperature of the battery through heating during charging. The voltage efficiency may be increased by decreasing the temperature of the battery through cooling or introducing low-temperature external air during discharging. When low-temperature external air is introduced, power consumption caused cooling may be reduced.

In winter, the voltage efficiency may be increased by heating during charging and introducing external air during discharging, or when the voltage efficiency increase effect is small, power consumption may be reduced by not introducing external air.

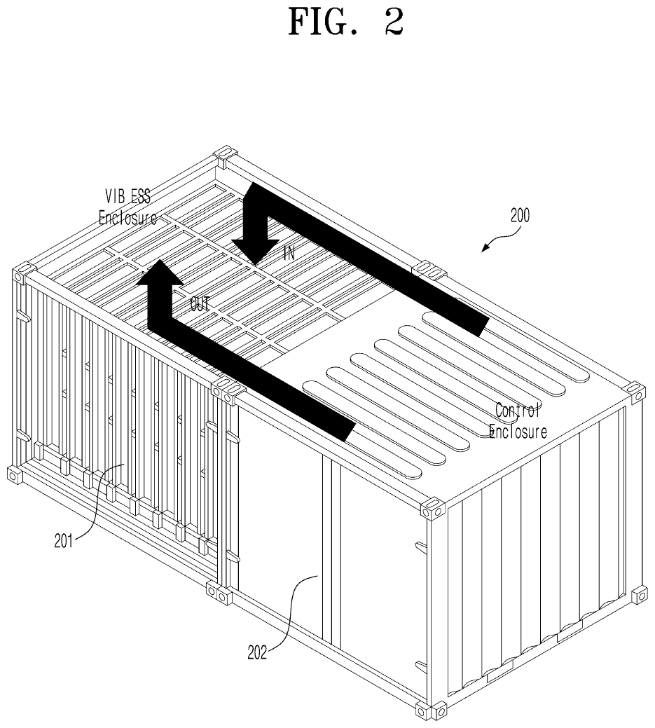

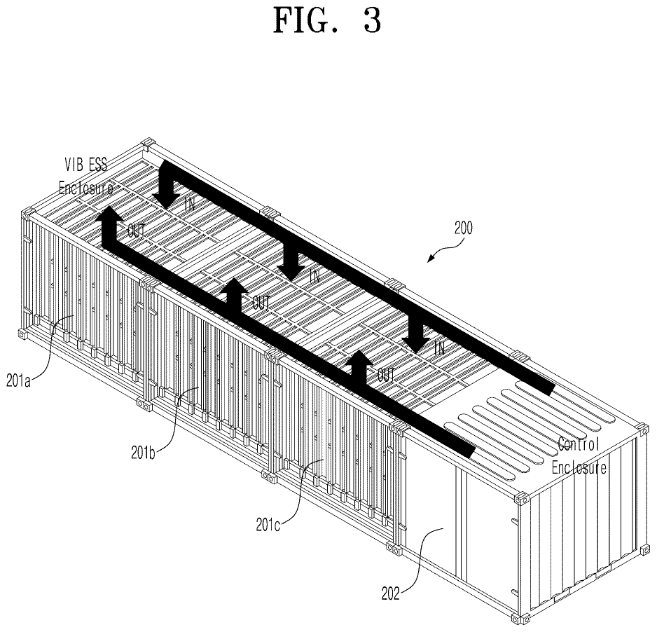

FIGS. 2 and 3 illustrate the structure of a container including a battery according to embodiments.

A container 200 of FIGS. 2 and 3 includes a battery charging/discharging system and/or an ESS including the battery charging/discharging system. The container 200 may be referred to as a battery temperature control system.

The container 200 may include a vanadium ion battery energy storage system (VIB ESS) 201 and/or a control device 202 for controlling battery charging/discharging.

The VIB ESS 201 includes a battery. The battery may be a vanadium ion battery.

An ESS may include a battery, a battery management system (BMS), a power conversion system (PCS), an energy management system (EMS), and the like. The battery has one or more cells, a plurality of cells form one module, and a plurality of modules may form one pack or rack. The ESS configured in this way may be connected to a power network, an electric network, a power grid, or the like to receive power.

When the most commonly used lithium-ion battery (LIB) is applied to the ESS, it may be used within a limited voltage range in consideration of battery safety. When a voltage imbalance occurs in a specific battery or battery group in the BMS, it is treated and controlled in the same way as an emergency situation caused by other factors such as high temperature, thus limiting its utilization.

In addition, in the case where the LIB is applied to the ESS, when a signal from a specific BMS is missing or the voltage of a specific cell is at a very low level close to OV, a cell or module corresponding to the specific BMS is blocked in consideration of the risk of fire. However, when the ESS is applied in a remote area or a war-torn area where access for easy maintenance is difficult, its utilization is limited.

In a battery, a module may be formed by grouping 10 to 20 cells, starting from the smallest cell unit, a plurality of modules may form a pack, and a plurality of packs may form a system level. According to this structure, the BMS may also have a hierarchical structure of cell BMS, module BMS (level 1), pack BMS (level 2), and system BMS (level 3).

A VIB module in the ESS 201 includes a plurality of VIB cells stacked in one direction. The VIB module has a long rectangular parallelepiped shape in the stacking direction of the VIB cells. The VIB module may be installed by being inserted into a VIB pack.

The ESS 201 may be arranged separately into a plurality of enclosures or strings 201a, 201b, and 201c, and each of the enclosures or strings 201a, 201b, and 201c may include a plurality of modules and packs, and include a BMS for each unit.

Although the control device 202 for controlling the operation of the ESS 201 is shown as one block, the control device 202 may specifically include a PCS, a system BMS, and the like, and may also include a heater, ventilator, and air conditioner (HVAC).

The battery system 200 includes an HVAC 202 for controlling the operating temperature of the ESS 201. The HVAC 202 includes a sensor for sensing the temperature of the ESS 201 to control the operating temperature of the ESS 201, and may discharge air to the outside or introduce external air into the system to control the temperature for high voltage efficiency of the ESS 201.

Space efficiency may be increased by arranging the components using the internal space of the battery system as illustrated in FIGS. 2 and 3.

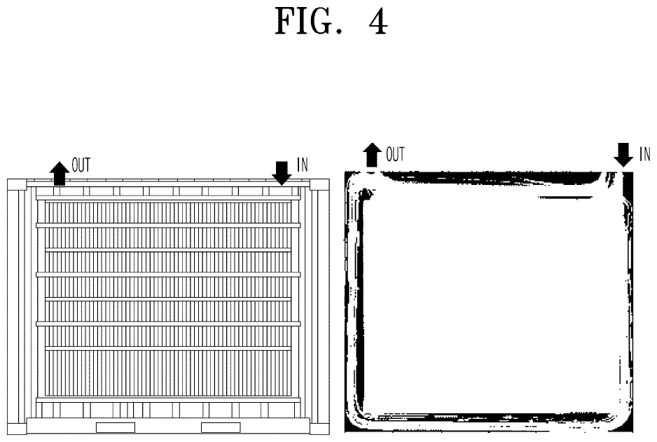

FIG. 4 illustrates control of external air of a container including a battery according to embodiments.

FIG. 4 illustrates a process in which the system 200 of FIGS. 2 and 3 controls the temperature of the system through the control device 202 for voltage efficiency improvement of the ESS 201 and/or emergency response.

To increase the temperature of the ESS 201, when the external temperature of the system 200 is higher than the internal temperature of the ESS 201, external air may be introduced into the ESS 201.

To increase the temperature of the ESS 201, when the external temperature of the system 200 is higher than the internal temperature of the ESS 201, internal air may be discharged from the ESS 201.

To decrease the temperature of the ESS 201, when the external temperature of the system 200 is lower than the internal temperature of the ESS 201, external air may be introduced into the ESS 201.

To decrease the temperature of the ESS 201, when the external temperature of the system 200 is lower than the internal temperature of the ESS 201, internal air may be discharged from the ESS 201.

Referring to FIGS. 2, 3, and 4, the battery is included in the container, and the battery is charged while increasing the temperature of the battery within a range where the voltage efficiency of the battery increases. The container includes a device for introducing/discharging external air, and the temperature of the battery in the container is controlled by the device for introducing/discharging external air.

Referring to FIGS. 2, 3, and 4, the battery is discharged while decreasing the temperature of the battery within a range where the voltage efficiency of the battery increases. The container includes the device for introducing/discharging external air, and the temperature of the battery in the container is controlled by the device for introducing/discharging external air.

The device for introducing external air according to embodiments may be a fan for introducing/discharging external air. Further, the device for introducing external air according to embodiments may be a flap that may be opened and closed.

Controlling the temperature of the battery further includes increasing the temperature of the battery within a first range while the battery is being charged, and decreasing the temperature of the battery within a second range while the battery is being discharged, and the temperature of the battery is controlled by the device for introducing and discharging external air, connected to the container.

For example, the first range for charging of the battery may be set to 20 to 40 °C, and the second range for discharging of the battery may be set to 0 °C or higher.

Controlling the temperature of the battery may include increasing the temperature of the battery by discharging internal air of the container when the external temperature is higher than the battery temperature while the battery is being charged, or may further include decreasing the temperature of the battery by discharging internal air of the container when the external temperature is lower than the battery temperature while the battery is being discharged.

Referring to FIGS. 2, 3, and 4, the battery is a vanadium ion battery, and the container including the battery is an ESS that performs charging and discharging of the vanadium ion battery.

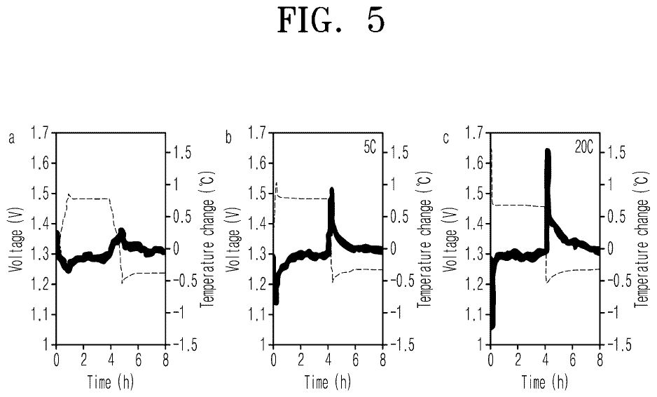

FIG. 5 illustrates temperature control based on charging and discharging of a battery according to embodiments.

FIG. 5 is a diagram illustrating changes in the temperature of the battery of the ESS 201 according to C-rates of the battery during charging and discharging of the battery in the battery temperature control system 200 of FIGS. 2 to 4. ‘a’ represents the case of 1C, ‘b’ represents the case of 5C, and ‘c’ represents the case of 20C.

Referring to FIG. 5, it may be seen that the temperature drops sharply when the battery is charged. Conversely, it may be seen that the temperature rises sharply when the battery is discharged. It may also be seen that the rate of this temperature change varies in proportion to the C-rate of the battery.

In the event of an emergency in the battery system 200, for example, a fire risk, a method for efficiently and quickly stabilizing the temperature of the ESS 201 is required. Although the temperature of the battery in the ESS 201 may be stabilized through a separate device such as the control device 202, a method for stabilizing the temperature of the battery in an emergency by the ESS 201 itself, instead of an external device, may be more effective.

Embodiments may decrease the temperature of the battery by using endothermic and/or exothermic reactions generated during charging and discharging of the battery.

The charging process of a battery is a process in which a substance with a low energy level changes into a substance with a high energy level, and an endothermic reaction occurs that absorbs heat from the surroundings. Herein, when the amount of heat absorption is greater than heat generated due to Joule heating, the temperature of the battery decreases. In particular, there is an effect of decreasing the temperature of an active material where a direct reaction occurs.

The battery generally tends to increase in efficiency at up to 40 to 50 °C, and then decrease in stability due to side reactions or unusual chemical reactions. Especially in the case of an ESS where a large number of batteries are bundled into a system, there is a possibility that performance deviations may occur between batteries during this process. That is, the ESS system may be sensitive to external air.

When the battery system temperature and/or the external air temperature increases to or above a specific level while the SOC of the battery is maintained at or below a specific level, charging the battery may be safer in terms of temperature.

The battery temperature control system 200 according to embodiments may measure a battery temperature and/or an external temperature, observe a system demand, start battery charging, and perform a temperature stabilization control process in preparation for an emergency.

The battery temperature control system 200 according to embodiments may measure a battery temperature and/or an external temperature, observe a system demand, start battery discharging, and perform a temperature stabilization control process in preparation for an emergency.

As such, the embodiments have an effect of stabilizing the temperature of the battery by using charging and discharging of the battery, in addition to an external air conditioning device.

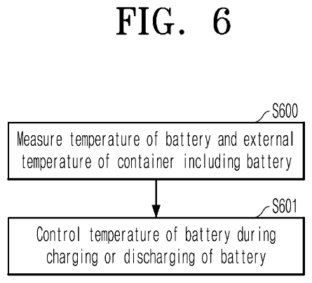

FIG. 6 illustrates a method for controlling a temperature of a battery according to embodiments.

FIG. 6 illustrates a method for controlling a temperature through external air during battery charging as described with reference to FIGS. 2 to 4.

The method for controlling a temperature of a battery according to embodiments may include measuring the temperature of the battery and an external temperature of a container including the battery (S600).

The method for controlling a temperature of a battery according to the embodiments may further include controlling the temperature of the battery during charging or discharging of the battery (S601).

The method for controlling a temperature of a battery includes measuring the temperature of the battery and the external temperature of the container including the battery during control of charging or discharging of the battery, and controlling to increase the temperature of the battery by introducing external air of the container when the external temperature is higher than the battery temperature during charging of the battery, or to decrease the temperature of the battery by introducing external air of the container when the external temperature is lower than the battery temperature during discharging of the battery.

That is, as illustrated in FIG. 1, the temperature of the battery may be controlled through external air to increase the voltage efficiency of the battery during charging and discharging.

For example, the battery may be charged at 20 to 40 °C during charging, and the battery may be discharged at 0 °C or higher during discharging.

The container may include the battery and a control device for the battery, the battery may be included in the container as one or more packs including a module of cells or modules of cells, and the control device may include an HVAC and a PCS.

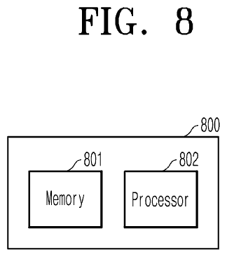

The method of FIG. 6 may be performed by the ESS system of FIGS. 2 to 3 including a processor of FIG. 8.

For example, a system for controlling a temperature of a battery during charging of the battery may include a HVAC for controlling air in a container including the battery, and a processor for controlling the temperature of the battery. The processor may include means for measuring at least one of the temperature of the battery or an external temperature of the container, and may control the HVAC to increase the temperature of the battery by heating air within the container or controlling air based on a value of the measured temperature during charging of the battery.

When the air in the container is heated during charging of the battery, the temperature of the battery is increased through heating only during charging of the battery, and heating is not performed during discharging of the battery.

Similarly, a system for controlling a temperature of a battery during discharging of the battery may include a HVAC for controlling air in a container including the battery, and a processor for controlling the temperature of the battery. The processor may include means for measuring at least one of the temperature of the battery or an external temperature of the container, and control the HVAC to decrease the temperature of the battery by cooling air within the container or controlling air based on a value of the measured temperature during discharging of the battery.

When the air within the container is cooled during discharging of the battery, the temperature of the battery is decreased through cooling only during discharging of the battery, and cooling is not performed during charging of the battery.

Accordingly, the embodiments have an effect of maximizing the voltage efficiency of the battery by efficiently using external air.

In addition, since heating and/or cooling is performed while maximizing voltage efficiency during charging and discharging, it has an effect of very efficiently controlling power consumption caused by unnecessary heating and/or cooling from an economic perspective.

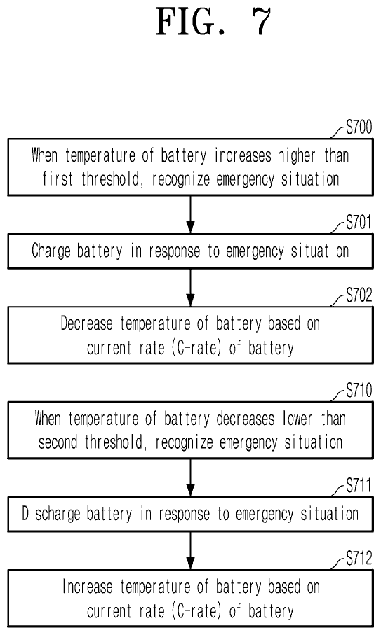

FIG. 7 illustrates a method for controlling a temperature of a battery in an emergency situation according to embodiments.

FIG. 7 illustrates a method for controlling a temperature of a battery in an emergency situation as described with reference to FIG. 5.

The method for controlling a temperature of a battery in an emergency situation may include a method for decreasing the temperature of the battery, S700, S701, and S702 and/or a method for decreasing the temperature of the battery, S710, S711, and S712.

Each of the steps S700, S701, and S702 of the method for decreasing a temperature of a battery in an emergency situation is as follows.

The method for controlling a temperature of a battery in an emergency situation according to embodiments may include recognizing the emergency situation, when the temperature of the battery increases higher than a first threshold (S700).

The method for controlling a temperature of a battery in an emergency situation according to embodiments may further include charging the battery in response to the emergency situation (S701).

The method for controlling a temperature of a battery in an emergency situation according to embodiments may further include decreasing the temperature of the battery based on a C-rate of the battery (S702).

Each of the steps S710, S711, and S712 of the method for increasing a temperature of a battery in an emergency situation is as follows.

The method for controlling a temperature of a battery in an emergency situation according to embodiments may further include recognizing the emergency situation, when the temperature of the battery decreases lower than a second threshold (S710).

The method for controlling a temperature of a battery in an emergency situation according to embodiments may further include discharging the battery in response to the emergency situation (S711).

The method for controlling a temperature of a battery in an emergency situation according to embodiments may further include increasing the temperature of the battery based on the C-rate of the battery (S712).

A first increase rate of the temperature of the battery when the C-rate of the battery has a first value is greater than a second increase rate of the temperature of the battery when the C-rate of the battery has a second value smaller than the first value, and a first decrease rate of the temperature when the C-rate of the battery has the first value is greater than a second decrease rate of the temperature of the battery when the C-rate of the battery has the second value smaller than the first value.

For example, as illustrated in FIG. 5, the temperature of the battery may change at a greater rate when the C-rate of the battery is 20C than when the C-rate of the battery is 1C. That is, the embodiments have an effect of stabilizing the temperature more quickly in proportion to the value of the C-rate of the battery.

That is, the temperature of the battery is stabilized by charging or discharging the battery in an emergency situation. Further, the battery is a vanadium ion battery, and the container including the battery is an ESS that performs charging and discharging for the vanadium ion battery. The container may include the battery and a control device for the battery, the battery may be included in the container as one or more packs including a module of cells or modules of cells, and the control device may include a HVAC and a PCS.

FIG. 8 illustrates a system for controlling a temperature of a battery according to embodiments.

FIG. 8 is a block diagram illustrating a system for performing the method of controlling a temperature of a battery in FIG. 6.

A system 800 may be included in the battery temperature control system 200. For example, the system 800 may be included in the control device 202 and include a memory 801 and/or a processor 802.

The system for controlling a temperature of a battery may include the memory 801 storing information about the temperature of the battery and the processor 802 connected to the memory and controlling the temperature of the battery. The processor 802 may be configured to measure the temperature of the battery and an external temperature of a container including the battery, charge or discharge the battery, and control the temperature of the battery. Controlling the temperature of the battery may include increasing the temperature of the battery by introducing external air of the container when the external temperature is higher than the battery temperature during charging of the battery, or include decreasing the temperature of the battery by introducing external air of the container when the external temperature is lower than the battery temperature during discharging of the battery.

FIG. 8 may also be a block diagram illustrating a system for performing the method of controlling a temperature of a battery in FIG. 7.

The system 800 for controlling a temperature of a battery in an emergency situation may include the memory 801 storing information about the temperature of the battery and the processor 802 connected to the memory and controlling the temperature of the battery. The processor 802 may be configured to recognize the emergency situation when the temperature of the battery increases higher than a first threshold, charge the battery in response to the emergency situation, decrease the temperature of the battery based on a C-rate rate of the battery, recognize the emergency situation when the temperature of the battery decreases lower than a second threshold, discharge the battery in response to the emergency situation, and increase the temperature of the battery based on the C-rate of the battery.

The first threshold and the second threshold according to embodiments may be reference values for determining an emergency situation of the ESS 201. The thresholds may be thresholds indicating safe margin ranges for battery charging and discharging. They may be thresholds for determining an emergency situation, when the temperature increases higher than a specific temperature or decreases lower than a specific temperature. Each threshold may be defined according to the system 200.

Due to the embodiments, the battery temperature control device may increase the charging/discharging voltage efficiency of the battery by using external air. In addition, although an external air conditioning system may be used in response to an emergency situation, the temperature may be quickly stabilized by using the charging/discharging reaction effect of the battery and the configuration of the battery, even without an external air conditioning system. An ESS that is efficient in voltage, cost, and space may be configured.

The embodiments have been described in terms of a method and/or an apparatus, and the description of the method and the description of the apparatus may be applied to complement each other.

For convenience of explanation, each drawing has been described separately, but it is also possible to design a new embodiment by merging the embodiments described in each drawing. In addition, according to the needs of those skilled in the art, designing a computer-readable recording medium recording a program for executing the foregoing embodiments also falls within the scope of the embodiments. The apparatus and method according to the embodiments are not limited to the configurations and methods of the embodiments described above, but all or part of the embodiments may be selectively combined so that various modifications can be made. Although preferred embodiments of the embodiments have been shown and described, the embodiments are not limited to the specific embodiments described above, and may be used in the technical field to which the embodiments pertain without departing from the subject matter of the embodiments claimed in the claims. Obviously, various modifications can be made by those skilled in the art, and these modifications should not be understood individually from the technical ideas or perspectives of the embodiments.

Various components of a device according to embodiments may be implemented in hardware, software, firmware, or a combination thereof. Various components of the embodiments may be implemented as a single chip, for example, one hardware circuit. According to embodiments, components according to the embodiments may be implemented as separate chips. According to embodiments, at least one of components of the device according to embodiments may include at least one processor capable of executing at least one program, and the at least one program may execute or include instructions for executing at least one of operations/methods according to embodiments. The executable instructions for performing the methods/operations of the device according to embodiments may be stored in a non-transitory CRM or other computer program products configured to be executed by the at least one processor, or may be stored in a transitory CRM or other computer program products configured to be executed by the at least one processor. Additionally, memory according to embodiments may be used to conceptually include not only volatile memory (e.g., RAM, etc.) but also non-volatile memory, flash memory, and PROM. Additionally, it may also be implemented in the form of carrier waves, such as transmission over the Internet. Additionally, a processor-readable recording medium may be distributed in a computer system connected to a network, so that a processor-readable code may be stored and executed in a distributed manner.

In this document, “/“and”,” are interpreted as “and/or.” For example, “A/B” is interpreted as “A and/or B”, and “A, B” is interpreted as “A and/or B”. Additionally, “A/B/C” means “at least one of A, B and/or C.” Additionally, “A, B, C” also means “at least one of A, B and/or C.” Additionally, in this document, “or” is interpreted as “and/or.” For example, “A or B” may mean 1) only “A”, 2) only “B”, or 3) “A and B”. In other words, “or” in this document may mean “additionally or alternatively.”

Terms such as first, second, and so on may be used to describe various components of embodiments. However, the interpretation of various components according to embodiments should not be limited by the above terms. These terms are merely used to distinguish one component from another. For example, a first user input signal may be referred to as a second user input signal. Similarly, the second user input signal may be referred to as the first user input signal. Use of these terms should be interpreted without departing from the scope of various embodiments. Although the first user input signal and the second user input signal are both user input signals, they do not mean the same user input signals unless clearly indicated in the context.

Terms used to describe embodiments are for the purpose of describing specific embodiments, and are not intended to limit the embodiments. As used in the description of the embodiments and the claims, a singular form is intended to include plural referents unless the context clearly dictates otherwise. The expression and/or is used in a sense that includes all possible combinations between the terms. The expression describes the presence of features, numbers, steps, elements, and/or components, and does not imply the absence of additional features, numbers, steps, elements, and/or components. Conditional expressions such as when, when, and so on used to describe embodiments are not limited to optional cases. It is intended that when a specific condition is satisfied, a relevant operation is performed or a relevant definition is interpreted in response to the specific condition.

Additionally, operations according to embodiments described in this document may be performed by a transmitting and receiving device including a memory and/or a processor according to embodiments. The memory may store programs for processing/controlling operations according to embodiments, and the processor may control various operations described in this document. A processor may be referred to as a controller or the like. In embodiments, operations may be performed by firmware, software, and/or a combination thereof, and the firmware, software, and/or combination thereof may be stored in the processor or the memory.

Meanwhile, operations according to the above-described embodiments may be performed by a transmitting device and/or a receiving device according to embodiments. The transmitting device and/or the receiving device may include a transceiver that transmits and receives media data, a memory that stores instructions (program code, algorithm, flowchart and/or data) for a process according to embodiments, and a processor that controls the operations of the transmitting device and/or the receiving device.

A processor may be referred to as a controller or the like, and correspond to, for example, hardware, software, and/or a combination thereof. Operations according to the above-described embodiments may be performed by the processor.

### MODE FOR INVENTION

As described above, relevant content has been described in the best mode for carrying out the invention.

### INDUSTRIAL APPLICABILITY

As described above, the embodiments are applicable wholly or partially to a battery temperature control device and system.

Those skilled in the art may change or modify the embodiments within the scope of the embodiments.

The embodiments may include changes/modifications, and the changes/modifications do not depart from the scope of the claims and their equivalents.

1. A method of controlling a temperature of a battery, the method comprising:
during control of charging or discharging of the battery, measuring the temperature of the battery and an external temperature of a container including the battery; and
upon detecting that the external temperature is higher than the temperature of the battery during charging of the battery, controlling to increase the temperature of the battery by introducing external air outside of the container, or
upon detecting that the external temperature is lower than the temperature of the battery during discharging of the battery, controlling to decrease the temperature of the battery by introducing external air outside of the container.

2. The method of claim 1,
wherein controlling to increase the temperature of the battery comprises increasing the temperature of the battery within a first range during charging of the battery; and
wherein controlling to decrease the temperature of the battery comprises decreasing the temperature of the battery within a second range during discharging of the battery,
wherein the temperature of the battery is controlled by a device for introducing and discharging the external air, connected to the container,
wherein the first range for charging of the battery is 20 to 40 °C, and
wherein the second range for discharging of the battery is 0 °C and higher.

3. The method of claim 1, wherein controlling the temperature of the battery comprises, upon detecting that the external temperature is higher than the temperature of the battery while the battery is being charged, increasing the temperature of the battery by discharging internal air of the container, or upon detecting that the external temperature is lower than the temperature of the battery while the battery is being discharged, decreasing the temperature of the battery by discharging internal air of the container.

4. A system for controlling a temperature of a battery, the system comprising:
a memory storing information about the temperature of the battery; and
a processor connected to the memory and configured to control the temperature of the battery,
wherein the processor includes:
means for measuring the temperature of the battery and an external temperature of a container including the battery; and
means for controlling the temperature of the battery configured to, upon detecting that the external temperature is higher than the temperature of the battery during charging of the battery, increase the temperature of the battery by introducing external air outside of the container, or upon detecting that the external temperature is lower than the temperature of the battery during discharging of the battery, decrease the temperature of the battery by introducing external air outside of the container.

5. The system of claim 4, wherein the means for controlling the temperature of the battery is configured to increase the temperature of the battery within a first range during charging of the battery, and decrease the temperature of the battery within a second range during discharging of the battery, and
wherein the temperature of the battery is controlled by a device for introducing and discharging the external air, connected to the container,
wherein the first range for charging of the battery is 20 to 40 °C, and
wherein the second range for discharging of the battery is 0 °C and higher.

6. The system of claim 4, wherein the means for controlling the temperature of the battery is configured to, upon detecting that the external temperature is higher than the temperature of the battery during charging of the battery, increase the temperature of the battery by discharging internal air of the container, and upon detecting that the external temperature is lower than the temperature of the battery during discharging of the battery, decrease the temperature of the battery by discharging internal air of the container.

7. The system of claim 4, wherein the battery is a vanadium ion battery, and
wherein the container is an energy storage system (ESS) configured for charging and discharging the vanadium ion battery.

8. The system of claim 7, wherein the container includes the battery and a control device for the battery,
wherein the battery is included in the container as one or more packs including a module or cells or modules of cells, and
wherein the control device includes one or more of a heater, a ventilator, and an air conditioner (HVAC), and a power conversion system (PCS).

9. A method for controlling a temperature of a battery in an emergency situation, the method comprising:
upon detecting that the temperature of the battery increases above first threshold, recognizing the emergency situation;
charging the battery in response to the emergency situation; and
decreasing the temperature of the battery based on a current rate (C-rate) of the battery; or
upon detecting that the temperature of the battery decreases below second threshold, recognizing the emergency situation;
discharging the battery in response to the emergency situation; and
increasing the temperature of the battery based on the C-rate of the battery.

10. The method of claim 9, wherein a first increase rate of the temperature of the battery when the C-rate of the battery has a first value is greater than a second increase rate of the temperature of the battery when the C-rate of the battery has a second value smaller than the first value,
wherein a first decrease rate of the temperature of the battery when the C-rate of the battery has the first value is greater than a second decrease rate of the temperature of the battery when the C-rate of the battery has the second value smaller than the first value, and
wherein the temperature of the battery is stabilized by charging or discharging the battery in the emergency situation.

11. The method of claim 9, wherein the battery is a vanadium ion battery, and
wherein a container including the battery is an energy storage system (ESS) charging and discharging the vanadium ion battery.

12. The method of claim 11, wherein the container includes the battery and a control device for the battery,
wherein the battery is included in the container as one or more packs including a module of cells or modules of cells, and
wherein the control device includes one or more of a heater, a ventilator, and an air conditioner (HVAC), and a power conversion system (PCS).

13. A system for controlling a temperature of a battery in an emergency situation, the system comprising:
a memory storing information about the temperature of the battery; and
a processor connected to the memory and controlling the temperature of the battery,
wherein the processor is configured to:
when temperature of the battery increases higher than a first threshold value, recognize an emergency situation;
charge the battery in response to the emergency situation;
decrease the temperature of the battery based on a current rate (C-rate) of the battery;
when the temperature of the battery decreases lower than a second threshold value, recognize the emergency situation;
discharge the battery in response to the emergency situation; and
increase the temperature of the battery based on the C-rate of the battery.

14. The system of claim 13, wherein a first increase rate of the temperature of the battery when the C-rate of the battery has a first value is greater than a second increase rate of the temperature of the battery when the C-rate of the battery has a second value smaller than the first value, and
wherein a first decrease rate of the temperature of the battery when the C-rate of the battery has the first value is greater than a second decrease rate of the temperature of the battery when the C-rate of the battery has the second value smaller than the first value,
wherein the temperature of the battery is stabilized by charging or discharging the battery in the emergency situation.

15. The system of claim 13, wherein the battery is a vanadium ion battery, and
wherein a container including the battery is an energy storage system (ESS) charging and discharging the vanadium ion battery.

16. The system of claim 15, wherein the container includes the battery and a control device for the battery,
wherein the battery is included in the container as a module of cells or one or more packs including modules of cells, and
wherein the control device includes one or more of a heater, a ventilator, and an air conditioner (HVAC), and a power conversion system (PCS).

17. A system for controlling a temperature of a battery during charging of the battery, the system comprising:
a heater, a ventilator, and an air conditioner (HVAC) controlling air of a container including the battery; and
a processor controlling the temperature of the battery,
wherein the processor includes means for measuring at least one of the temperature of the battery or an external temperature of the container, and
wherein the processor controls the HVAC to increase the temperature of the battery by heating air within the container or controlling air based on a value of the measured temperature during charging of the battery.

18. The system of claim 17, wherein when the air within the container is heated during charging of the battery, the temperature of the battery is increased through heating only during charging of the battery, and heating is not performed during discharging of the battery.

19. A system for controlling a temperature of a battery during discharging of the battery, the system comprising:
a heater, a ventilator, and an air conditioner (HVAC) controlling air of a container including the battery; and
a processor controlling the temperature of the battery,
wherein the processor includes means for measuring at least one of the temperature of the battery or an external temperature of the container, and
wherein the processor controls the HVAC to decrease the temperature of the battery by cooling air within the container or controlling air based on a value of the measured temperature during discharging of the battery.

20. The system of claim 19, wherein when the air within the container is cooled during discharging of the battery, the temperature of the battery is decreased through cooling only during discharging of the battery, and cooling is not performed during charging of the battery.
